(19) United States
(12) Patent Application Publication
(10) Pub. No.: US 2006/0074831 A1
(43) Pub. Date: Apr. 6, 2006

(54) Virtual assistant

(76) Inventors: Andrew D. Hyder, Minnetonka, MN (US); Scott Bjerstedt, Minneapolis, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 10/944,927

(22) Filed: Sep. 20, 2004

(51) Int. Cl. G06N 5/00; G06F 17/00

(52) U.S. Cl. 706/45

(57) ABSTRACT

The invention is a computer implemented business method that provides a virtual assistant or human-like operator interface for web sites.

### FIELD OF THE INVENTION

The present invention relates generally to software based inventions and more particularly to artificial intelligence system. The software modules cooperate with hardware and the internet to form a virtual assistant associated with a web site. The virtual assistant helps users of the web site navigate the web site and learn more about the products and services offered by the web site. In this sense the software system mimics the behavior of a human customer service representative.

### BACKGROUND OF THE INVENTION

It is quite common for a web site to have an interactive chat line with a customer service representative who can interact with the visitor to a web site and inform them in greater detail about products, services or other web-based content. A live human customer service representative is extremely expensive and as the web site traffic increases, the cost of additional human representatives increases proportionately.

In an effort to provide the functionality of a human service representative, some web managers have adopted “chatterbox” and other forms of artificial intelligence (AI) that attempt to mimic the operation of a human operator. The principal drawback to known implementations of artificial intelligence-based virtual assistance is that they undergo training at one time and then and are released for use. Although such systems interact with users they do not learn from their interaction with visitors to the web site. As a consequence additional training if required, is done “offline” in a separate training session.

Essentially all AI systems for use in this area pareses incoming text with a “natural language processor”. Natural language processing is both common and commercially available for both written language and spoken language. Suitable natural language processors can be acquired from a variety of sources including “Ask Jeeves” and SRI international. These systems are complex but simply stated they parse an input text stream and in response they output or return a text stream to the user. The text returned is composed by the AI engine based upon data present in the knowledge base (KB) of the system. In conventional use the KB is trained in an offline session and then operated in online sessions with a so called “AI engine”. The quality of the response depends in part on the ability of the AI engine and in part on the quality of the training process that created the KB.

### SUMMARY OF THE INVENTION

In contrast to prior art artificial intelligence-based virtual assistant or Customer Service Representative (CSR) of the present invention includes a human operator that interacts episodically with users of the web site through certain software called “OPS”. As a consequence of these interactions the knowledgebase (KB) of the virtual assistant continuously learns from its interaction with the human operator and the visitors to the web site. Typically, the visitor's questions will be answered automatically by the artificial intelligence engine and the associated knowledgebase, however certain questions may not be well handled or answered by the automatic system. These problematic queries are referred to or sent to the human operator.

The human operator can interact with a visitor in a conventional “chat” mode but more importantly the human operator can map new and potentially problematic queries to existing well handled queries with known answers. This episodic human interaction improves the knowledge base and is called “tying”. Tying is one aspect of the invention. As a consequence of “tying” the next time a similar query is receive, the system will answer appropriately and automatically.

The human operator may operate or interact with the website visitor in real time or the human operator may periodically interact with a queue of accumulated queries or questions. The queue contains questions posed by visitors to the web site, which were not “well handled” by the knowledgebase and the artificial intelligence engine. In this instance, the operator can map or tie the incoming questions to questions which have an answer appropriate for the incoming question. Although this operation requires human intelligence, the tying process allows the non specialist human operator to upgrade or improve the performance of the automatic system as a normal and integral part of system operator.

In addition to the human operator the CSR virtual assistant is also capable of carrying on a conversational dialogue with a web site user or visitor. This bidirectional conversation is extremely useful in most applications of the software even though it may not be used extensive by the system. In this instance, a query posed by a web site visitor is not answered by mapping to a known answer, rather the question maps to a return question posed by the CSR virtual assistant. The web site user then answers the question posed by the virtual assistant, which may either map to an answer or an additional question. Each interaction or exchange is called a “tier” and a series of conversational interactions can be considered as a multiple tiered conversation thread.

The human operator can view a conversation thread and “associate” two dialogues together. This is not the same as the “tying” operation described above. In the associating process you are connecting a new question or tier of questions to be served to the web site visitor. In uses the AI engine now looks for the appropriate response to an incoming text stream in the associated tier. This associating process mimics a natural progression of conversation and deepens the thread by adding a tier.

The practical benefit of the associating process is that the website visitor is more likely to collect the information he desires without human intervention. Although this associating process is in contrast to the tying process previously described, which connects two different questions that have the same meaning, is has a similar benefit that the human operator is able to improve the automatic performance of the system though an intuitive and natural interaction with a real website visitor posing real questions. The examples in the remainder of the specification make the tying and associating process clear.

### BRIEF DESCRIPTION OF THE DRAWINGS

Through the figures identical reference numerals indicate identical items, wherein:

FIG. 1 shows the context of the system;

FIG. 2 shows a schematic diagram of a first tier interaction;

FIG. 3 shows a schematic diagram of a tying operation;

FIG. 4 shows a schematic diagram of a first tier interaction after a tying operation;

FIG. 5 shows a schematic diagram of a multiple tier interaction; and

FIG. 6 shows the development of a multiple tier conversation thread and the associating process.

### DETAILED DESCRIPTION OF THE INVENTION

Context and Definitions

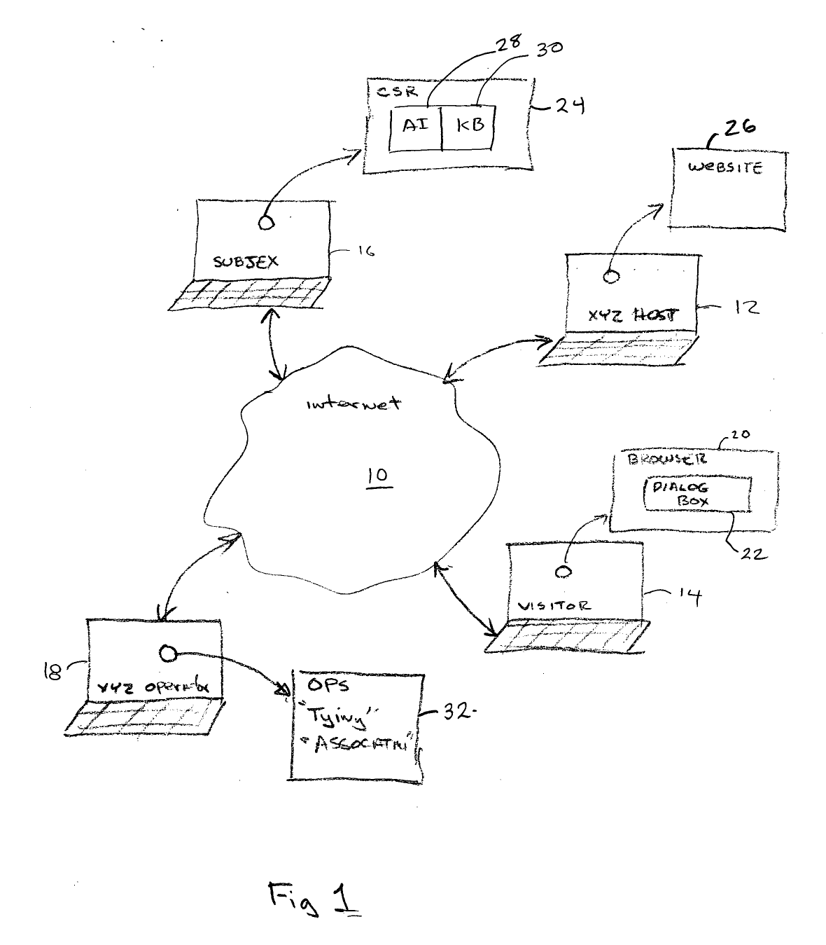

FIG. 1 shows the context of the invention and the overall system topology. The internet 10 provides communication between several computers shown as computer 12 computer 14 computer 16 and computer 18. Assume for the sake of the illustrative examples that the XYZ corporation hosts a website (WS) on computer 12. The XYZ corporation offers two products “A” and “B” for sale through the website. A visitor operating computer 14 connects to the to the XYZ website interacts with the computer 12 through a browser on his computer 14. The browser software 20 shows a dialog box 22. This dialog box 22 accepts text from the user of computer 14 and returns text from CSR software running on computer 24 or from a human operator operating Ops software 32 on computer 18. In the example, the visitor operating computer 14 is a potential customer of the XYZ corporation and seeks to buy product “A” from the XYZ website.

For example the visitor on computer 14 may interact automatically with the Customer Service Representative (CSR) software 24 residing on and operating on the Subjex computer 16. The CSR software product residing on the Subjex computer 16 creates the “virtual assistant” experience for the visitor at computer 14. The CSR software includes an artificial intelligence engine 28 of conventional design and construction coupled to and interacting with a knowledge base 30 (KB) that is unique to the XYZ corporation. The XYZ corporation also has a human operator who is operating computer 18. This human involved with the XYZ site is called “operator”.

In general the XYZ corporation hosts the XYZ “Website” (WS) from computer 12 and employs the human operator of computer 18. This operator trains the knowledge base (KB) 30 that is hosted as part of the CSR software 24 on computer 16. The operator has a “Manager” program called OPS.

### EXAMPLES

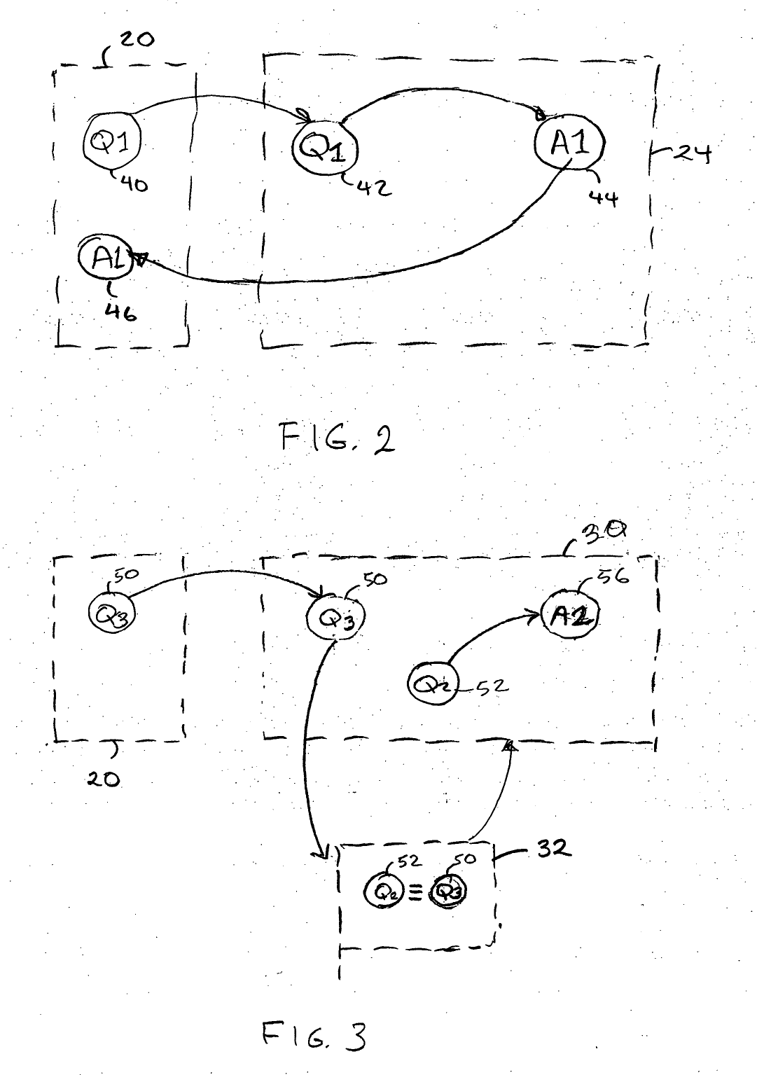

FIG. 2 shows a simple but exemplary transaction between a visitor and the CSR. The visitor operating computer 14 accesses the XYZ website (WS) hosted on computer 12 through the internet 10. The visitor types a text 40 query “Q1” into the dialogue box 22 that appears in his browser 20. The query Q1 is sent to the CSR 24 residing on computer 16, which parses the question Q1 and looks for an appropriate answer with the AI engine 28 and the XYZ knowledgebase 30. If the question is well handled an answer 46 shown as AI is sent back the visitor and it appears in dialogue box 20 as well.

Tying

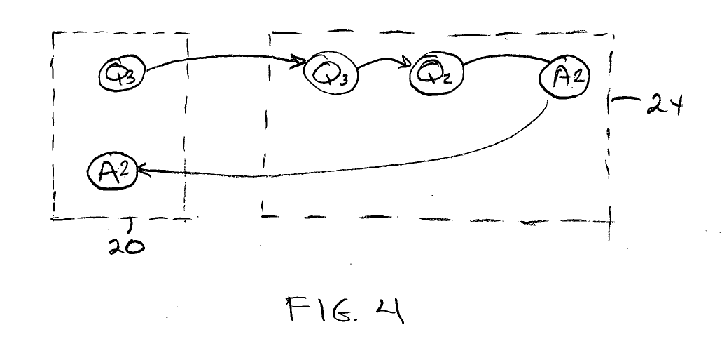

FIG. 3 shows an interaction giving rise to the tying process. Assume that the potential customer operating computer 14 (FIG. 1) want to know the hours of service of the XYZ corporation. A query 50 or text Q3 such as “RU opn now?” is typed into the dialogue box 22 and it is passed to the artificial intelligence engine 28 of the CSR software operating on the Subjex computer 16 via the internet. This text has unconventional syntax and misspellings which are not well handled. Since this question is not recognized by the AI engine it is passed to queue of questions stored and resident in the OPS software that the human operator is using on computer 18. The human operator using OPS software 32 may readily understand the query 50 as a request for hours of operation. The human operator ties this query Q3 question 50 to the hours question 52. This tying operation shown in box 32 in FIG. 3 updates the knowledge base 30 so that the next time query 50 text Q3 is parsed it will provoke answer 56 text labeled A2 in shown in FIG. 4.

Associating

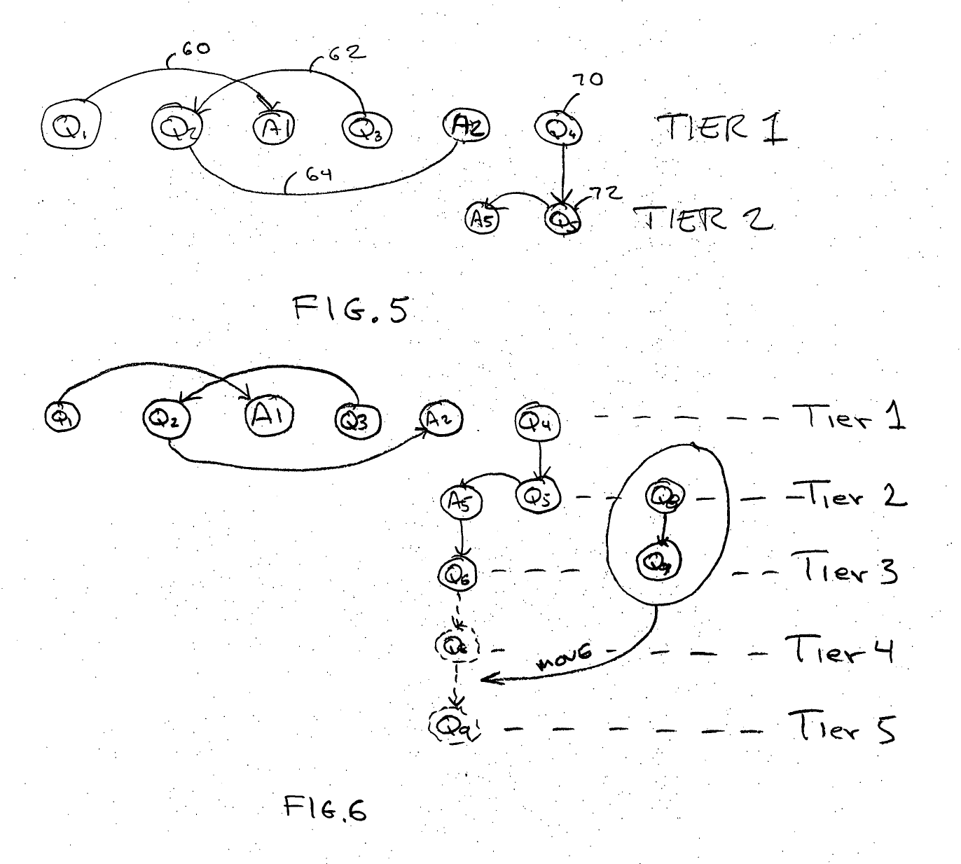

FIG. 5 shows some of the information in FIGS. 1-4 in a slightly different format. In FIGS. 2, 3 and 4 input text streams such as Q1, Q2 and Q3 are presented to the system and they provoke output text streams A1 and A2. In FIG. 5 these interactions are all shown on one line of the figure showing a so called first tier. For example the query text Q1 is parsed into the answer text A1 as indicated by arrow 60. Query text Q3 is “tied” to query text Q2 indicated by arrow 62 and it is parsed to answer text A2 as indicated by arrow 64.

FIG. 5 also shows associating process as follows. In this example the visitor asks question 70 which may be query test Q4 or “how much does it cost”. This query Q4 is parsed by the AI engine and is understood as a pricing request. However in our example the customer has not identified which product is of interest. In this example the AI engine selects and serves a return query text Q5 to the browser window. The Q5 text or query 72 may be “Are you interested in product A or our product B”. This text response is a tier 2 text and it is sent to the browser window. The visitor may then type “B”. The AI engine returns answer 74 or text A5 which is the price for “B”. When a tier 2 text is sent the Ai will begin parsing the returned text at the second tier level. This substantially constrains the process of finding a “correct” reply.

However that the context of the answer is known from the conversation encompassing tier I and tier II. If the initial query was just the letter “B” an entirely different conversation may take place. If during a multiple tier conversation the AI engine cannot posit the correct question or answer this conversation is referred to the human operator. In the example suppose that the provoked response 8 is not “B” but rather “the red one in the lower left hand corner of the website”. The Human operator readily associates this response with the price of “B” and creates an new level of conversation or tier by asking “I think you want to buy product “B”. The Associating process creates new questions to associates this conversation thread with the price of product B. Thus “associating” deepens the level of conversation until the AI engine unambiguously “knows” which product is desired by the visitor.

Most queries are well handled and are of tier 1. simple but unrecognized questions are tied to the text in the first tier. However more obscure or confusion queries provoke a tier 2 text from the CSR and the AI/KB system looks for a response parsed at the tier 2 level. For example the returned text “B” in tier 1 is senseless while in tier 2 and in multi-tier context the meaning of statement “B” is clear and unambiguous.

The associating process allows the human operator of OPS to connect or couple a multi-tier dialog with a query or answer text in any other tier. Generally the operator will “deepen” the number of tiers. FIG. 6 shows that an operator using the OPS software can move a multi tier dialog consisting of Q8 and Q9 to connect it with Q6 within tier 2. This associating process deepens the dialog by two tiers so that the knowledgebase now responds to Q6 with Q8. When parsing reply or response text the AI engine looks across tier 4 first and if no suitable response is found the AI engines searches the next higher tier and so forth. Once again, questions that are not well handled are referred to the human operator using OPS 32 on computer 18.

What is claimed is:

1) A computerized method for converting input text received over the internet from a user and formulating output text delivered to the user comprising:
creating a knowledgebase connected to an artificial intelligence engine residing on an internet connected computer;
parsing and said input text with said artificial intelligence engine and said knowledgebase to look up an appropriate output text, and
dividing input text into well handled input texts and not well handled input texts, and in response to well handled input text;
sending appropriate output text to said user over the internet; and in response to not well handled input text;
sending the not well handled input text to a remote operator over the internet; and,
tying not well handled input text to well handled input text in said knowledgebase by said human operator.

2) A computerized method for converting input text received over the internet from a user and formulating output text delivered to the user comprising:
creating a knowledgebase connected to an artificial intelligence engine residing on an internet connected computer; said knowledge base having a first tier and a second tier;
parsing and said input text with said artificial intelligence engine and said knowledgebase to look up an appropriate output text in a first tier of said knowledgebase, and
dividing input text into well handled input texts and not well handled input texts, and in response to well handled input text;
sending appropriate output text to said user over the internet; and in response to not well handled input text;
sending the not well handled input text to a remote operator over the internet;
associating not well handled input text to well handled input text in a second tier in said knowledgebase.
